(19) United States
(12) Patent Application Publication
(10) Pub. No.: US 2025/0313412 A1
(43) Pub. Date: Oct. 9, 2025

(54) END PIECE FOR A PROFILED PART AND IN PARTICULAR FOR A GUIDE ROLLER

(71) Applicant: EPSILON COMPOSITE, GAILLAN-EN-MEDOC (FR)

(72) Inventor: Sébastien SOUBAIGNE, Lesparre-Médoc (FR)

(21) Appl. No.: 18/860,536

(22) PCT Filed: Apr. 28, 2023
(86) PCT No.: PCT/EP2023/061198

§ 371 Date: Oct. 25, 2024

(30) Foreign Application Priority Data
May 2, 2022 (FR) FR2204133

(51) Int. Cl. B65G 39/02; B29C 48/00; B29C 48/355

(52) U.S. Cl. CPC B65G 39/02; B29C 48/355; B29C 48/0018

(57) ABSTRACT

An end piece for a profiled part is disclosed having a longitudinal axis ZZ, the dimensions of which allow it to be force-fitted into one end of the profiled part, the end piece including at least one cylindrical inner housing for accommodating a rotary adjustment member or a rotary working member in order to rotatably mount the profiled part on a fixed shaft, and the housing being terminated by an inwardly facing wall forming a stop for the rotary adjustment member or rotary working member. The end piece is flexible and includes, on its outer surface, a plurality of fins that project outward and extend longitudinally along the axis ZZ of the inner edge of the end piece in the direction of the outer face of the end piece, the fins being separated by grooves that extend longitudinally along the axis ZZ in the same direction as the fins.

The present invention relates to the technical field of profiled parts and guide rollers for machines for processing or producing plastic films or the like, comprising a profiled part provided with end pieces in which bearings and pins are incorporated for mounting the rotary assembly on a fixed frame, and relates in particular to an end piece for a profiled part and in particular for a guide roller.

### STATE OF THE ART

The rollers of particular interest to us are those used in the manufacture of plastic film by extrusion blow-molding. They are generally made from aluminum tubing and fitted at the end with aluminum end pieces into which bearings and shafts are inserted to secure the freely rotating roller to a frame provided for the purpose. Aluminum tubes are manufactured using extrusion processes. End pieces are fastened by shrink-fitting, gluing or machining. When the aluminum end piece is shrink-fitted into the aluminum tube, the thermal expansion between the two parts is constant, and the tube is strong enough not to crack.

However, aluminum rollers do have their drawbacks. The mass and inertia of aluminum rollers prevent them from being used at high rotational speeds, so they are replaced by rollers made from carbon tubing, themselves manufactured by rolling or filament winding processes. These types of processes produce stress-resistant rollers, but the manufacturing process does not allow for continuous production and is costly.

When the aluminum end piece is shrink-fitted into the carbon tube manufactured using one of these processes, differential expansion phenomena between aluminum and carbon may be observed. The tightening set for a temperature of 20° C. will no longer be the same when the roller is subjected to a temperature of 80° C. during operation. The solution commonly used to compensate for this is to limit the clamping areas of the end piece in the carbon tube and to define an adhesive reserve. The structural adhesive injected into this reserve between the tube and the end piece absorbs expansion and holds the end pieces in position. However, this solution requires additional surface preparation and cleaning steps prior to bonding, and has other significant drawbacks, such as that of providing an extra-tight fit between the tube and the end piece, making it difficult to disassemble. What's more, as well as requiring considerable resources to dismantle an aluminum end piece bonded to a carbon tube, there is also the risk of tearing off carbon fibers and damaging the tube.

On the other hand, today's end pieces allow the bearings to be housed in them in a sliding arrangement, so that they can be removed and replaced several times if necessary during the balancing phase. During this phase, measurements are taken while the roller is rotating to assess any imbalances. Then, to correct the imbalances, the bearing is removed from the roller, so that mass can be introduced through the hole where the bearing used to be, and the bearing is replaced in the end piece, so that the roller can be rotated again, the imbalance measured again, and so on. The bearing must be easy to assemble and disassemble. This is why the bearing is slidably mounted in the end piece. This facilitates the balancing phase, but when the roller is permanently mounted on its final working frame, the slipping bearing leads to premature wear of the connectors, resulting in more frequent replacement of parts.

What's more, in the case of rollers used in the manufacture of plastic film by extrusion blow-molding, it's the plastic film that drives the roller, which can only withstand a very low load, unlike a conveyor roller system. Thus, for this type of application, the effort required to turn the roller must be as low as possible, and is obtained by reducing the mass as much as possible to achieve an acceptable residual unbalance, and also to be able to increase the roller's speed and/or length.

Finally, in the case of rollers made from carbon tubes themselves manufactured by a pultrusion process, it is important that any radial force exerted by the end piece on the tube is reduced to preserve the tube from bursting. In fact, the carbon tube manufactured using a pultrusion process is predominantly made up of carbon fibers running in the longitudinal direction (between 60 and 80% of fibers in the longitudinal direction), which makes it brittle in transverse planes.

### DESCRIPTION OF THE INVENTION

Therefore, the aim of the invention is to overcome these drawbacks by providing an end piece for a profiled part, adapted to receive a bearing for mounting the rotary assembly on a fixed shaft for easy assembly and disassembly, capable of absorbing expansion and avoiding bursting while providing a tight fit between the end piece and the profiled part.

Another object of the invention is to provide a method for assembling the end piece on a profiled part for a guide roller.

For this purpose, the invention has as its object an end piece for a profiled part in the form of a tube with circular inner cross-section having a longitudinal axis ZZ, the dimensions of which are allow it to be force-fitted into one end of this profiled part, said end piece comprising at least one cylindrical inner housing for accommodating a rotary adjustment member or a rotary working member in order to rotatably mount the profiled part on a fixed shaft, and said housing being delimited by an inwardly facing wall forming a stop for said rotary adjustment member or said rotary working member;
wherein the end piece is flexible and comprises, on its outer surface, a plurality of fins that project outward and extend longitudinally along the axis ZZ of the inner edge of the end piece in the direction of the outer face of the end piece, said fins being separated by grooves that extend longitudinally along the axis ZZ in the same direction as the fins.

The invention also relates to an end piece defined in this way, wherein the outer surface of the end piece, adapted to contact the inner surface of the profiled part, fits into two cylindrical surfaces of different diameters, a positioning surface and a clamping surface, said positioning surface being located just after a cone-shaped guide surface located on the side of the inner end of the end piece, said positioning surface being shaped to have a diameter less than or equal to the inner diameter of the profiled part and said clamping surface being shaped to have a diameter greater than the inner diameter of the profiled part. The invention also relates to a device so defined, wherein the positioning surface is shaped to have a diameter equal to or less than the inner diameter of the profiled part by at most 0.1 mm; and
the clamping surface is shaped to have a diameter greater than the inner diameter of the profiled part by between 0.2 and 0.4 mm.

The invention also relates to an end piece defined in this way, wherein the length of the periphery of the end piece along a cross-section and at the location of the surface of said fins intended to come into contact with the inner surface of the profiled part corresponds between 20% and 90% to the length of the total periphery of the section into which the end piece fits so that the contact of the end piece with the profiled part is discontinuous. The invention also relates to an end piece defined in this way, wherein the depth of the grooves is greater than the width of the fins.

The invention also relates to an end piece defined in this way, comprising on its outer end a flange designed to bear against the edge of the profiled part.

The invention also relates to an end piece defined in this way, comprising:
an oblique inwardly-facing annular wall and an annular lip on the inner end of the end piece, forming an inwardly-facing annular end wall;
a first cylindrical inner housing for accommodating an adjustment bearing, said adjustment bearing being slidably mounted to facilitate its removal from the end piece and to facilitate profiled part balancing operations, and the housing being terminated by the annular wall, the end piece comprising a second cylindrical inner housing with a diameter smaller than the diameter of said first housing, located in the extension of the annular wall, said second housing being designed to accommodating a working bearing of smaller diameter than the adjustment bearing mounted tightly when the adjustment bearing is not in the end piece, said second housing being located between the annular lip and the annular wall, the annular wall being oblique in order to facilitate the insertion of the working bearing into the end piece.

The invention also relates to an end piece defined in this way, manufactured by injection molding of a composite such as thermoplastic loaded with conductive particles.

The invention also relates to an end piece defined in this way, made predominantly of a flexible material with a Young's modulus of between 3 and 40 GPa, and preferably between 5 and 25 GPa.

The invention also relates to an assembly comprising at least one end piece defined in this way and a profiled part in the form of a tube with a circular inner cross-section and a longitudinal axis ZZ, the end piece being force-fitted inside one end of the profiled part, the assembly further comprising at least one rotary working member and at least one rotary adjustment member.

The invention also relates to an assembly defined in this way, wherein the contact surface of the rotary working member with the end piece is entirely in the part of the end piece located between a first and a second transverse plane and wherein the positioning surface extends longitudinally along the axis ZZ, the first and second transverse planes and being perpendicular with respect to the longitudinal axis ZZ of symmetry of the end piece.

The invention also relates to an assembly defined in this way, wherein the rotary working member is a working bearing.

The invention also relates to an assembly defined in this way, wherein the rotary adjustment member is an adjustment bearing adapter or an adjustment bearing.

The invention also relates to an assembly defined in this way, into which is inserted:
either the adjustment bearing adapter or the adjustment bearing intended for use in the balancing operation of a roller, the adjustment bearing adapter and the adjustment bearing comprising an outer ring, the diameter of the part of the outer ring in contact with the inner wall of the cylindrical housing being equal to, or up to 0.1 mm smaller than, the diameter of the cylindrical inner housing in order to be slidably mounted,
or the working bearing intended for use on a production machine, the working bearing having an outer diameter equal to, or up to 0.1 mm greater than, the diameter of the cylindrical inner housing in order to be tightly mounted.

The invention also relates to an assembly defined in this way, wherein the length of the first housing along axis ZZ is such that when the adjustment bearing is inserted therein and in abutment against the annular wall, the outer cylindrical wall of the adjustment bearing in contact with the wall of the housing is a strip whose surface area is between 66% and 90% of the entire outer cylindrical wall of the adjustment bearing.

The invention also relates to an assembly defined in this way, wherein the contact surface of the adjustment bearing with the end piece is entirely in the part of the end piece located between the second transverse plane and a third transverse plane and wherein the clamping surface extends longitudinally along the axis ZZ, the transverse plane being perpendicular with respect to the longitudinal symmetry ZZ of the end piece.

The invention also relates to an assembly defined in this way, wherein the diameter of the first housing intended to receive the adjustment bearing is equal to or up to 0.1 mm greater than the outer diameter of the adjustment bearing, while the diameter of the second housing intended to accommodate the working bearing is equal to or up to 0.1 mm and preferably up to 0.05 mm smaller than the outer diameter of the working bearing.

The invention also relates to an assembly defined in this way, wherein the diameter of the working bearing is at least 2 mm smaller than the diameter of the adjustment bearing.

The invention also relates to an assembly defined in this way, wherein the profiled part is made of carbon, is manufactured using a pultrusion method and comprises between 60% and 80% fibers in the longitudinal direction.

The invention also relates to a method for assembling a fixed-shaft work frame and guide roller for a plastic film processing or production machine by means of an assembly defined in this way comprising a plurality of end pieces each comprising:
an oblique inwardly-facing annular wall and an annular lip on the inner end of the end piece, forming an inwardly-facing annular end wall, and
a first cylindrical inner housing for accommodating an adjustment bearing, said adjustment bearing being slidably mounted to facilitate its removal from the end piece and to facilitate profiled part balancing operations, and the housing being terminated by the annular wall, the end piece comprising a second cylindrical inner housing with a diameter smaller than the diameter of said first housing, located in the extension of the annular wall, said second housing being designed to accommodating a working bearing of smaller diameter than the adjustment bearing mounted tightly when the adjustment bearing is not in the end piece, said second housing being located between the annular lip and the annular wall, the annular wall being oblique in order to facilitate the insertion of the working bearing into the end piece,

the method comprising the steps of:
a) Pressing an end piece into each end of the profiled part, forming a guide roller, until the outer end of the end piece, forming a flange, comes to rest against the edge of the profiled part,
b) Inserting adjustment bearings into first housings of each end piece sized so that the bearing is slidably mounted therein, said first housing being located inside the end piece on the side of its outer end, between the flange and an inwardly-facing annular wall which serves as a stop for the adjustment bearing,
c) Assembling the adjustment bearings on fixed shafts,
d) Rotating the profiled part and measuring any imbalances,
e) Disassembling the profiled part from the adjustment bearings, and correcting the imbalance by adding mass into the tube,
f) Putting the profiled part with the end pieces back on the adjustment bearings and shafts. g) Rotating the profiled part again and measuring any imbalances,
e) Disassembling the profiled part from the adjustment bearings, and correcting the imbalance by adding or removing mass into/from the profiled part,
i) Repeating steps f) to h) until the imbalance has been reduced to within the tolerated limits,
j) Assembling the working bearings onto fixed shafts,
k) Inserting an assembly composed of working bearings, axles, and sealing caps into second housings of each end piece, sized so that the bearing is fitted tightly therein, said second housing being located inside the end piece on the side of its inner end after the first housing, between an inwardly-facing annular lip and the annular wall which guides the working bearing when it is inserted into the end piece.

The invention also relates to an assembly method defined in this way, wherein the bearings are inserted into the end piece by cold-shrinking.

### BRIEF DESCRIPTION OF THE FIGURES

The purposes, objects and features of the invention will become clearer upon reading the following description made with reference to the drawings wherein:

FIG. 1 shows a longitudinal section of a profiled part equipped with the device of the invention and mounted on a fixed shaft,

FIG. 2 shows a longitudinal section of a profiled part equipped with the device of the invention and mounted on a fixed working shaft,

FIG. 3 shows a longitudinal section of a profiled part equipped with a variant of the device of the invention and mounted on a fixed shaft,

FIG. 4 shows a longitudinal section of a profiled part equipped with a variant of the device of the invention and mounted on a fixed working shaft,

FIG. 5 shows a cross-section of the device of the invention,

FIG. 6 shows a longitudinal section of the device of the invention shown in FIGS. 1 and 2,

FIG. 7 shows a cross-section of the device of the invention according to the variant shown in FIGS. 3 and 4,

FIG. 8 shows a perspective view of the device of the invention according to the variant shown in FIGS. 3, 4, and 7.

### DETAILED DESCRIPTION OF THE INVENTION

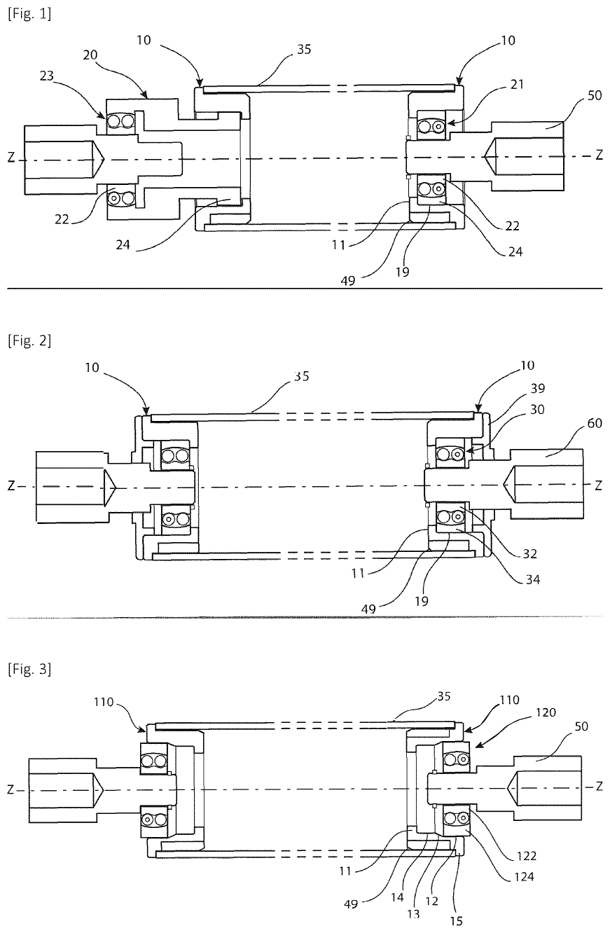

FIGS. 1 to 4 show a longitudinal section of a profiled part 35 fitted at both ends with the end piece according to the invention. In the remainder of the description, the profiled part 35 is also referred to as a tube, and the term “roller” refers to the rotary assembly.

However, the profiled part 35 could have a non-circular cross-section without departing from the scope of the invention. The main embodiment of the invention is shown in FIGS. 1 and 2. Each end of the tube 35 is fitted with an end piece 10, the majority of which is inserted into the tube and the outer end of which protrudes radially to form a flange 15 designed to abut against the edge of the tube 35. The end piece 10 is hollow and comprises a housing 19 adapted to hold a rotary adjustment member 20 or 21 or a rotary working member 30. The profiled part 35 shown in FIG. 1 is fitted with the rotary adjustment member 20 on its left-hand end and the rotary adjustment member 21 on its right-hand end, but in practice the profiled parts are generally fitted with identical rotary adjustment members at both ends.

The rotary adjustment member is an adjustment bearing adapter 20 comprising an adjustment bearing 23 or is an adjustment bearing 21 while the rotary working member is a working bearing 30. For both types of rotary adjustment members, the adjustment bearings 21 and 23 are designed to rotate freely around a shaft 50 with longitudinal axis ZZ, while the bearing 30 is designed to rotate freely around a shaft 60 with longitudinal axis ZZ.

The end piece 10 further comprises an annular lip 11 on the inner end of the end piece, forming an inwardly-facing annular end wall and forming a stop against which the rotary adjustment member 20 or 21 or the rotary working member 30 rests. The adjustment bearing adapter 20 or bearing 21 or 30 is inserted into the end piece 10, preferably by press-fitting or cold-shrinking.

The rotary adjustment and working members are assemblies comprising an outer ring 24, respectively 34, an inner ring 22, respectively 32 and a plurality of balls or the like to provide low-friction rotation of the outer ring about the inner ring, the outer ring 24 or 34 being adapted to come into contact with the inner wall of the cylindrical housing 19 of the end piece 10. The outer diameter of the part of the rotating member in contact with the end piece is different depending on whether it is the rotary adjustment member used for the roller balancing operation or the working rotating member used when the roller is placed on the production machine. The rotary adjustment member is an adjustment piece designed to be removed from the end piece 10 and inserted into the end piece 10 several times to enable the roller balancing operation.

To carry out the balancing operation, the end pieces 10 are press-fitted into the tube 35, the adjustment bearing adapters 20 or the adjustment bearings 21 are assembled onto the fixed shafts 50 and then inserted into the housings 19 of each end piece 10. The tube 35 is rotated, and any imbalances are measured. The tube is then disassembled from the adjustment bearing adapters 20 or the adjustment bearings 21, and the imbalance is corrected by adding mass into the tube. The tube fitted with the end pieces is then placed back onto the adjustment bearing adapters 20 or the adjustment bearings 21 and shafts 50, the tube is rotated again, and the imbalance is measured and corrected again by adding or removing mass. These steps are repeated until the balancing error has been reduced to within the tolerated limits. Successive mounting and dismounting of the tube 35 on the shafts 50 is made possible by adjustment bearing adapters 20 or adjustment bearings 21 slidably mounted in the cylindrical housing 19 of the end pieces 10. When the profiled part or tube 35 is made of carbon and manufactured using a pultrusion method, the balancing time is longer because the rollers have more defects than ones made of aluminum or carbon using a rolling or filament winding method, and this ease of disassembly is essential.

The dimensions of the adjustment bearing adapter 20 or adjustment bearing 21 used for the balancing operation must allow the outer ring 24 to be slidably mounted relative to the end piece 10 for easy removal, while providing sufficient contact for the end piece 10 to drive the outer ring 24 of the adjustment bearing adapter 20 or adjustment bearing 21. Preferably, the outer diameter of the part of the outer ring 24 in contact with the inner wall of the cylindrical housing 19 is such that it is equal to or up to 0.1 millimeters smaller than the diameter of the cylindrical inner housing 19.

For production operations, the rotary working member is a working bearing 30 whose outer diameter is 0.1 mm to 0.2 mm greater than the outer diameter of the adjustment bearing 21 or the outer diameter of the part of the outer ring 24 in contact with the inner wall of the cylindrical housing 19, so as to enable the outer ring 34 of the working bearing 30 to be mounted tightly in the end piece 10 and unable to slide, in order to ensure that the end piece 10 is driven by the outer ring 34 of the working bearing 30 without any risk of premature wear of the links. Preferably, the diameter of the working bearing 30 is equal to, or up to 0.1 millimeters greater than, the diameter of the cylindrical housing 19.

The working bearing 30 is mounted on the shaft 60 and then inserted into the end piece 10 when the roller is balanced in its final working position, such as on a guide roller frame on a production machine. For this assembly, the assembly comprising the bearing 30 of the fixed shaft 60 and a sealing cap 39 is pushed into the housing 19 until it abuts the annular lip 11. The sealing cap 39 is used to protect the working bearing 30 from dust and liquid ingress.

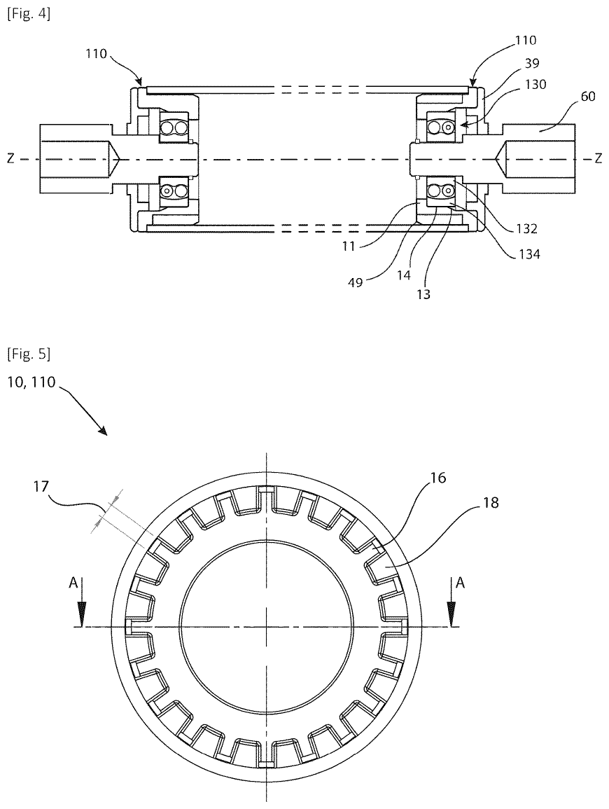

A variant embodiment of the device of the invention is shown in FIGS. 3 and 4, which show a longitudinal section of a profiled part 35 fitted at both ends with the end piece according to this variant. Each end of the profiled part or tube 35 is fitted with an end piece 110, the majority of which is inserted into the tube and the outer end of which protrudes radially to form a flange 15 designed to abut against the edge of the tube 35. The end piece 110 is hollow and comprises two housings 12 and 14 adapted to respectively contain a rotary adjustment member 120 and a rotary working member 130, the end piece being able to accommodate only one of the two members at a time. The rotary adjustment member 120 is preferably an adjustment bearing 120 and the rotary working member is preferably a working bearing 130. The end piece further comprises an annular lip 11 on the inner end of the end piece, forming an inwardly-facing annular end wall.

The bearings 120 and 130 are designed to rotate freely around a fixed shaft 50 and 60 respectively with the longitudinal axis ZZ. The bearings 120 and 130 are inserted into the end piece, preferably by press-fitting or cold-shrinking.

The first cylindrical inner housing 12, located on the outer end of the end piece 10, is designed to accommodate an adjustment bearing 120 used for the roller balancing operation, as shown in FIG. 3. The adjustment bearing 120 is an assembly consisting of an outer ring 124, an inner ring 122 and a plurality of balls or the like to provide low-friction rotation of the outer ring around the inner ring. The dimensions of the first housing 12 must allow the outer ring 124 of the adjustment bearing 120 to be slidably mounted with respect to the end piece so that it can be easily removed, while providing sufficient contact for the end piece to drive the outer ring 124 of the adjustment bearing 120. Preferably, the diameter of the cylindrical inner housing 12 is equal to or up to 0.1 millimeters greater than the outer diameter of the adjustment bearing. On the inner end of the end piece, the first cylindrical housing 12 has an inwardly-facing annular wall 13 forming a stop against which the outer ring 124 of the adjustment bearing 120 is in abutment. When placed in the first cylindrical housing 12 against the annular wall 13, the adjustment bearing 120 protrudes from the end piece 10 as can be seen in FIG. 3. The length of the first housing 12 along the axis ZZ is such that when the adjustment bearing 120 is inserted therein and in abutment against the annular wall 13, the outer cylindrical wall of the bearing in contact with the wall of the housing represents a strip whose surface area is between 66% and 90% of the entire outer cylindrical wall of the adjustment bearing 120. This minimum surface area is both necessary and sufficient to ensure that the end piece can be driven, while at the same time reducing the mass of the end piece. Furthermore, the part of the bearing found outside the end piece makes it easy to remove. To carry out balancing operations, the end pieces 10 are press-fitted into the tube 35, and the adjustment bearings 120 are then inserted into the housings 12 of each end piece and assembled onto the fixed shafts 50. The tube 35 is rotated, and any imbalances are measured. The tube is then disassembled from the bearings 120, and the imbalance is corrected by adding mass into the tube. The tube fitted with the end pieces is then placed back onto the adjustment bearings 120 and shafts 50, the tube is rotated again, and the imbalance is measured and corrected again by adding or removing mass. These steps are repeated until the balancing error has been reduced to within the tolerated limits. Successive mounting and removal of the tube 35 onto/from the shafts 50 is made possible by adjustment bearings 120 slidably mounted in the first cylindrical housing 12 of the end pieces 110. When the profiled part or tube 35 is made of carbon and manufactured using a pultrusion method, the balancing time is longer because the rollers have more defects than ones made of aluminum or carbon using a rolling or filament winding method, and this ease of disassembly is essential.

The second cylindrical housing 14 is located inside the end piece 110 on the side of its inner end after the first housing 12, between the inwardly-facing annular lip 11 and the annular wall 13. The second cylindrical housing 14 has a diameter smaller than the diameter of the first housing and is designed to accommodate a working bearing 130 whose diameter is smaller than the diameter of the adjustment bearing 120 used for balancing operations. Preferably, the diameter of the working bearing 130 is at least 2 mm smaller than the diameter of the adjustment bearing 120. The working bearing 130, fixed shaft 60 and sealing cap 39 assembly is fitted into the end piece 110 when the roller is balanced in its final working position, as shown in FIG. 4, for example on a shaft for a guide roller. For this assembly, the bearing 130 is pushed into the end piece and the oblique annular wall 13 guides the bearing 130 and prevents it from being positioned askew in the second housing 14, the bearing being pushed into the housing until it abuts the annular lip 11. The dimensions of the second housing 14 must allow the outer ring 34 of the working bearing 130 to be mounted tightly with respect to the end piece to ensure that the end piece 10 is driven by the outer ring 34 of the working bearing 130. Preferably, the diameter of the second cylindrical housing 14 is equal to or up to 0.1 mm, preferably up to 0.05 mm, smaller than the outer diameter of the working bearing 130. When the working bearings 130 are in place on the fixed shafts 60, a sealing cap 35 is placed on each end piece 110 to protect the working bearings 130 from dust or liquid ingress.

The annular lip 11 of the end piece 110, located at the inner end of the end piece, forms a stop against which the working bearing 130 is in abutment. The outer ring 134 of the working bearing 130 is clamped in the end piece 110, so the working bearing 130 is integral with the end piece. The width of the second cylindrical housing 14 is less than or equal to the width of the outer cylindrical wall of the working bearing 130. Preferably, the length of the second cylindrical housing 14 along the axis ZZ is sized so that when the bearing is placed in its housing 14, the outer surface of the bearing in contact with the housing represents a strip whose surface area is between 66 and 90% of the total surface area of the outer wall of the working bearing 130, so that the surface area in contact is sufficient to guarantee driving while allowing the mass of the end piece to be reduced.

The end piece 10 or 110 is made of plastic, preferably by injection molding of a composite material composed, for example, of thermoplastic loaded with conductive particles such as carbon in the form of fibers so as to be conductive and to be able to discharge onto the fixed shaft the electrostatic charges which accumulate on the tube 35. The composite can also be composed of thermoplastic and fillers to increase the mechanical strength of the end piece and/or improve the end piece's behavior under varying thermal conditions. The load represents between 20 and 50% of the end piece. Generally speaking, the majority of the material used for the end piece is chosen from flexible materials so that the end piece has a Young's modulus of between 3 and 35 GPa and preferably between 5 and 25 GPa.

The end piece 10 or 110 has an external shape that corresponds substantially to the inner shape of the profiled part 35. More specifically, the inner cross-section of the profiled part and the cross-section of the end piece 10 or 110 have a complementary shape so that it can be force-fitted and friction-fitted into the profiled part. In the case of a tube 35, the end piece 10 or 110 has an outer surface of revolution which is inscribed in two cylindrical sections and which comprises a short entry cone which defines a guide surface 49 located on the side of the inner end of the end piece to facilitate its insertion into the tube.

The end piece 10 or 110 is shown in detail in FIG. 5, which shows a cross-section in a plane perpendicular to the longitudinal axis of symmetry ZZ. The outer face of the end piece 10 or 110 has fins 16 extending longitudinally along the axis ZZ between the flange 15 and the guide surface 49. The end piece 10 or 110 is sufficiently flexible to adapt to the inner diameter of the tube, which may be variable in the event of a manufacturing defect in the tube. The interaction between the end piece and the tube is enhanced by the presence of fins. The fins are equidistant from each other and there are at least three of them. For the example shown, and for a tube with an outer diameter of 40 mm and an inner diameter of 36 mm, the end piece preferably has twenty fins 16, equidistant from each other, whose face in contact with the inner surface of the tube has a width referenced 17 on the figure and equal to 2 mm. The length of the annular periphery of the end piece 10 or 110 at the surface of the fins intended to come into contact with the inner surface of the tube 35 is between 20% and 90% of the total length of the annular periphery into which the end piece fits at the fins, and is preferably between 60% and 80%. In this way, the contact between the end piece and the profiled part is discontinuous in the area of the fins, allowing lateral expansion of the fins when the end piece is fitted into the tube, while limiting radial expansion of the fins, which could cause the profiled part to burst. The fins are separated by grooves 18 extending longitudinally along the axis ZZ in the same direction as the fins. The grooves have a depth greater than the width of the fins, so that the fins can flatten when the end piece is pressed into the tube to provide a firm connection between tube and end piece, compensate for tube surface irregularities and absorb any out-of-roundness of the tube. The end piece 10 or 110 is thus friction-locked into the tube 35, while remaining removable. The depth of the grooves is preferably between 3 and 6 mm.

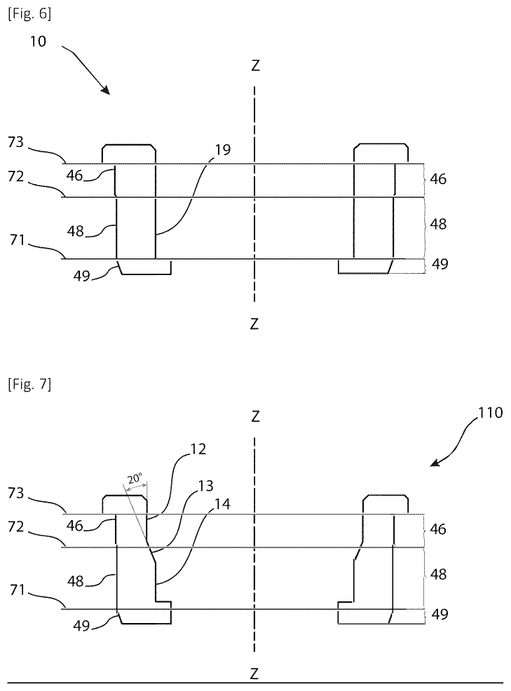

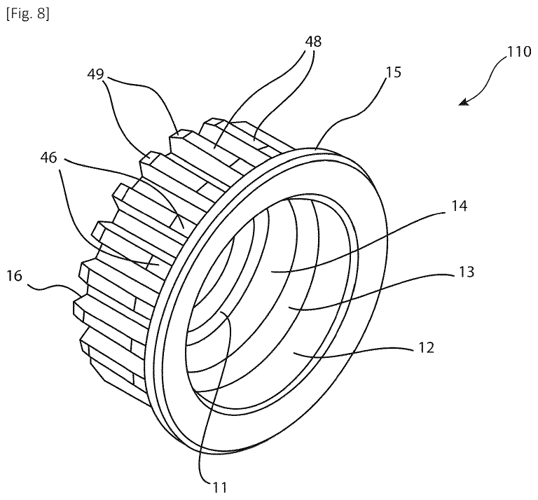

FIGS. 6 and 7 show a cross-section AA of FIG. 5, and show the end piece 10 and end piece 110, respectively, in a longitudinal section passing through the axis of symmetry ZZ. Common to both end pieces 10 and 100, the outer surface of the end piece in contact with the inner surface of the tube is inscribed in two cylindrical surfaces of different diameters, and corresponds to all the outer surfaces of the fins in contact with the tube. A first positioning surface 48 located just after the cone-shaped guide surface 49 and a clamping surface 46. The positioning surface 48 has a diameter equal to or less than the inner diameter of the tube 35. Advantageously, this positioning surface 48 has a diameter equal to or less than the inner diameter of the tube 35 by up to 0.3 mm and preferably between 0.05 and 0.3 mm. The clamping surface 46 has a diameter greater than the inner diameter of the tube 35. Preferably, and by no means restrictively, the difference in diameter between the clamping surface 46 and the inner diameter of the tube is between 0.2 and 0.4 mm. In other words, the diameter of the clamping surface 46 is greater than the diameter of the positioning surface, and this difference in diameter is between 0.1 mm and 0.6 mm. As the end piece is inserted into the tube on the side facing the guide surface 49, the positioning surface 48 first comes into contact with the inner surface of the tube and, by exerting constant pressure on the end piece, the latter penetrates the tube until the clamping surface comes into contact with the inner surface of the tube, thus increasing the pressure required to push the end piece into the tube as far as the flange 15. The end piece is held tightly in the tube mainly by the contact of the clamping surface with the inner surface of the tube. In this way, the end piece is intimately connected to the tube, but this interconnection is not permanent and can be removed without damaging the tube. The positioning surface extends longitudinally along the axis ZZ between a first transverse plane 71 passing through the junction with the guide surface 49 and a second transverse plane 72 passing through the junction with the clamping surface. The clamping surface extends longitudinally along the axis ZZ between the second transverse plane 72 and a third transverse plane 73 passing through the plane of the flange 15 of the end piece 110.

The contact surface of the rotary working member, i.e. the working bearing 30 and 130, with the end piece 10 and 110 respectively, is entirely in the part of the end piece located between the first and second transverse planes 71 and 72, into which the positioning surface extends. The contact surface of the adjustment bearing 21 or adjustment bearing adapter 20 with the end piece 10 and the contact surface of the adjustment bearing 120 with the end piece 110 are entirely in that part of the end piece 10 or 110 located between the second and third transverse planes 72 and 73 into which the clamping surface 46 extends. The transverse planes 71, 72 and 73 are perpendicular to the longitudinal axis of symmetry ZZ of the end piece 110.

In the case of the end piece 10 shown in FIG. 6, when it comes to inserting the working bearing 30 into the end piece, the housing 19 being adjusted so that the working bearing 30 is fitted tightly inside, the inner diameter of the end piece at the location of the housing 19 must not be reduced when the end piece is in the tube, so as not to prevent the working bearing 30 from being inserted. This is achieved by the outer diameter of the end piece being equal to or smaller than the inner diameter of the tube 35 by at most 0.1 mm between the transverse planes 71 and 72, i.e. at the positioning surface 48, which allows the end piece 10 to expand slightly outwards without damaging the tube. When the working bearing 30 is inserted into the housing 19 of the end piece 10, the force exerted by the end piece on the tube at the positioning surface is reduced because the outer diameter of the end piece is reduced at this surface and because the thickness of the end piece increases at the housing 19, increasing the annular rigidity thereof.

In the case of end piece 110 shown in FIG. 7, the force exerted by the end piece on the tube at the clamping surface may result in a slight reduction in the inner diameter of the end piece at the point in the housing 12 located between the transverse planes 72 and 73. This reduction in the inner diameter of the end piece is made possible by the end piece's thickness and flexibility, and protects the tube from bursting. On the other hand, this slight reduction in inner diameter does not prevent the insertion of the adjustment bearing 120, which is slidably mounted in the housing 12.

Likewise, when it comes to inserting the working bearing 130 into the end piece 110, the housing 14 being adjusted so that the working bearing is fitted tightly inside, the inner diameter of the end piece at the location of the housing 14 must not be reduced when the end piece is in the tube, so as not to prevent the working bearing 130 from being inserted. This is achieved by the outer diameter of the end piece being equal to or smaller than the inner diameter of the tube 35 by at most 0.1 mm between the transverse planes 71 and 72, i.e. at the positioning surface 48, which allows the end piece to expand slightly outwards without damaging the tube. Even when the working bearing 130 is inserted into the second housing 14 of the end piece 110, the force exerted by the end piece on the tube at the positioning surface is reduced because the outer diameter of the end piece is reduced at this surface and because the thickness of the end piece increases at the housing 14, increasing the annular rigidity thereof.

Indeed, it is important to reduce radial stress in order to prevent the tube from bursting. In fact, when the tube is made of carbon and manufactured using a pultrusion method is predominantly made up of carbon fibers running in the longitudinal direction (between 60 and 80% of fibers in the longitudinal direction), which makes it brittle in transverse planes. In fact, the bursting strength of a carbon tube manufactured by a pultrusion method is two to three times lower than the bursting strength of a carbon tube of the same dimensions manufactured by a filament winding method or by a rolling method that allows more fiber to be wound almost radially to the tube axis (between 60 and 90° to the longitudinal axis of the tube). Radial stress is also reduced thanks to the flexibility of the end piece 10 or 110 and the presence of fins, which absorb some of the stress applied to the profiled part. On the other hand, when the bearing is shrink-fitted into the profiled part 35, thanks to the fins on the end piece 10 or 110, the cross-section of the profiled part at the end piece is shaped to match the polygonal shape of the cross-section of the end piece at the fins. As a result, the elongation of the profiled part is lower than it would be on a rigid end piece with a full circular cross-section. As a result, neither the bearing nor the end piece is damaged when the bearings 120 or 130 are shrink-fitted on.

According to FIG. 8, a perspective view of the end piece 110, shows the location of parts of the clamping surfaces 46 and positioning surfaces 48 on the fins 16, as well as the annular wall 49 of each fin, on the outer surface of the end piece. Inside the end piece, the inner side of the end piece terminates in the annular lip 11. These features are shared with the end piece 10. On the other hand, features inside the end piece such as the housings 12 and 14, and the oblique annular wall 13, are specific to the end piece 110. Whatever the diameter of the tube 35, e.g. for a tube 35 with an inner diameter of 60 mm, the dimensions of the parts inside the end piece 10 or 110 are the same as for the end piece adapted for a tube with an inner diameter of 36 mm. The outer diameter of the end piece is adapted to the inner diameter of the tube by increasing the thickness of the wall of the end piece.

The end piece 10 or 110 according to the invention is particularly suitable for assembly on profiled parts serving as guide rollers, used, for example, in plastic film processing machines, fabric manufacturing machines, or on any other guide roller.

During operation, a guide roller can be subjected to significant temperature gradients of the order of 60° C., and the end piece 10 or 110, thanks to its flexibility and fins, is able to absorb the thermal expansion caused by the differential stress between the materials.

The end piece 10 or 110 according to the invention is preferably glued before being inserted into the tube to secure the end piece, but the gluing carried out is not a structural gluing, so it avoids the step of preparing the gluing surfaces and allows the end piece to be disassembled without tearing off material. The use of an injection-molded composite end piece combined with a pultruded profiled part makes it possible to lower the overall weight of the parts, and to reduce production costs. On the other hand, the lightening of parts has an impact on the roller's performance, as it reduces its inertia, makes balancing more accurate, and increases the maximum usable length for a given profiled part section. The end piece according to the invention offers a weight reduction of between 60 and 75% compared with an aluminum end piece.

Last but not least, the end piece increases the service life of the rollers, enabling them to be processed and recycled at the end of their life.

1. An end piece for a profiled part in the form of a tube with circular inner cross-section having a longitudinal axis ZZ, longitudinally delimited by an end of the end piece called the inner end, provided to extend into the profiled part, and an end of the end piece called the outer end, the dimensions of which are adapted to allow it to be force-fitted from the inner end into one end of this profiled part, said end piece comprising at least one cylindrical inner housing for accommodating a rotary adjustment member or a rotary working member in order to rotatably mount the profiled part on a fixed shaft, and said housing being delimited by an inwardly facing wall forming a stop for said rotary adjustment member or said rotary working member;
wherein the end piece is flexible and comprises, on its outer surface, a plurality of fins that project outward and extend longitudinally along the axis ZZ, said fins being separated by grooves that extend longitudinally along the axis ZZ in the same direction as the fins; and
wherein the fins of the outer surface of the end piece, adapted to be in contact with the inner surface of the profiled part, are shaped to define, in the direction defined from the inner end of the end piece towards the outer end of the end piece, a positioning surface and a clamping surface, said positioning surface being located just after a cone-shaped guiding surface located on the side of the inner end of the end piece, the positioning and clamping surfaces being inscribed in two cylindrical surfaces of different diameters, said positioning surface being shaped to have a diameter equal to or less than the inner diameter of the profiled part and said clamping surface being shaped to have a diameter greater than the inner diameter of the profiled part.

2. The end piece according to claim 1, wherein:
the positioning surface is shaped to have a diameter equal to or less than the inner diameter of the profiled part by at most 0.1 mm; and
the clamping surface is shaped to have a diameter greater than the inner diameter of the profiled part by between 0.2 and 0.4 mm.

3. The end piece according to claim 1, wherein the length of the periphery of the end piece along a cross-section and at the location of the surface of said fins intended to come into contact with the inner surface of the profiled part corresponds between 20% and 90% to the length of the total periphery of the section into which the end piece fits so that the contact of the end piece with the profiled part is discontinuous.

4. The end piece according to claim 1, wherein the depth of the grooves is greater than the width of the fins.

5. The end piece according to claim 1, comprising, on its outer end, a flange designed to abut against the edge of the profiled part.

6. The end piece according to claim 1, comprising:
an oblique inwardly-facing annular wall and an annular lip on the inner end of the end piece, forming an inwardly-facing annular end wall;
a first cylindrical inner housing for accommodating an adjustment bearing, said adjustment bearing being slidably mounted to facilitate its removal from the end piece and to facilitate profiled part balancing operations, and the housing being terminated by the annular wall, the end piece comprising a second cylindrical inner housing with a diameter smaller than the diameter of said first housing, located in the extension of the annular wall, said second housing being designed to accommodate a working bearing of smaller diameter than the adjustment bearing mounted tightly when the adjustment bearing is not in the end piece, said second housing being located between the annular lip and the annular wall, the annular wall being oblique in order to facilitate the insertion of the working bearing into the end piece.

7. The end piece according to claim 1, manufactured by injection molding of a composite such as thermoplastic filled with conductive particles.

8. The end piece according to claim 1, made predominantly of a flexible material with a Young's modulus of between 3 and 40 GPa.

9. An assembly comprising at least one end piece according to claim 1 and a profiled part in the form of a tube with circular inner cross-section and a longitudinal axis ZZ, the end piece being force-fitted inside one end of the profiled part, the assembly further comprising at least one rotary working member and at least one rotary adjustment member.

10. The assembly according to claim 9, wherein the contact surface of the rotary working member with the end piece is entirely in the part of the end piece located between a first and a second transverse plane and and wherein the positioning surface extends longitudinally along the axis ZZ, the first and second transverse planes and being perpendicular with respect to the longitudinal axis ZZ of symmetry of the end piece.

11. The assembly according to claim 9, wherein the rotary working member is a working bearing.

12. The assembly according to claim 9, wherein the rotary adjustment member is an adjustment bearing adapter or an adjustment bearing.

13. The assembly according to claim 9, into which is inserted:
either the adjustment bearing adapter or the adjustment bearing intended for use in the balancing operation of a roller, the adjustment bearing adapter and the adjustment bearing comprising an outer ring, the diameter of the part of the outer ring in contact with the inner wall of the cylindrical housing being equal to, or up to 0.1 mm smaller than, the diameter of the cylindrical inner housing in order to be slidably mounted,
or the working bearing intended for use on a production machine, the working bearing having an outer diameter equal to, or up to 0.1 mm greater than, the diameter of the cylindrical inner housing in order to be tightly mounted.

14. The assembly according to claim 13, wherein the length of the first housing along the axis ZZ is such that when the adjustment bearing is inserted therein and in abutment against the annular wall, the outer cylindrical wall of the adjustment bearing in contact with the wall of the housing represents a strip whose surface area is between 66% and 90% of the entire outer cylindrical wall of the adjustment bearing.

15. The assembly according to claim 13, wherein the contact surface of the adjustment bearing with the end piece is entirely in the part of the end piece located between the second transverse plane and a third transverse plane and wherein the clamping surface extends longitudinally along the axis ZZ, the transverse plane being perpendicular with respect to the longitudinal symmetry axis ZZ of the end piece.

16. The assembly according to claim 13, wherein the diameter of the first housing intended to receive the adjustment bearing is equal to, or up to 0.1 mm greater than, the outer diameter of the adjustment bearing, while the diameter of the second housing intended to accommodate the working bearing is equal to or up to 0.1 mm smaller than the outer diameter of the working bearing.

17. The assembly according to claim 13, wherein the diameter of the working bearing is at least 2 mm smaller than the diameter of the adjustment bearing.

18. The assembly according to claim 8, wherein the profiled part is made of carbon, is manufactured using a pultrusion method and comprises between 60% and 80% fibers in the longitudinal direction.

19. A method for assembling a work frame with fixed shafts and guide roller for a plastic film processing or production machine by means of an assembly according to claim 9, which comprises the steps of:
a) Pressing an end piece into each end of the profiled part, forming a guide roller, until the outer end of the end piece, forming a flange, comes to rest against the edge of the profiled part,
b) Inserting adjustment bearings into first housings of each end piece sized so that the bearing is slidably mounted therein, said first housing being located inside the end piece on the side of its outer end, between the flange and an inwardly-facing annular wall which serves as a stop for the adjustment bearing,
c) Assembling the adjustment bearings on fixed shafts,
d) Rotating the profiled part and measuring any imbalances,
e) Disassembling the profiled part from the adjustment bearings, and correcting the imbalance by adding mass into the tube,
f) Putting the profiled part with the end pieces back on the adjustment bearings and shafts,
g) Rotating the profiled part again and measuring any imbalances,
h) Disassembling the profiled part from the adjustment bearings, and correcting the imbalance by adding or removing mass into/from the profiled part,
i) Repeating steps f) to h) until the imbalance has been reduced to within the tolerated limits,
j) Assembling the working bearings onto fixed shafts,
k) Inserting an assembly composed of working bearings, axles, and sealing caps into second housings of each end piece, sized so that the bearing is fitted tightly therein, said second housing being located inside the end piece on the side of its inner end after the first housing, between an inwardly-facing annular lip and the annular wall which guides the working bearing when it is inserted into the end piece.

20. An assembly method according to claim 19, wherein the bearings are inserted into the end piece by cold-shrinking.
